(19) United States
(12) Patent Application Publication
(10) Pub. No.: US 2020/0139571 A1
(43) Pub. Date: May 7, 2020

(54) CUTTING LAND CONFIGURED TO BE USED IN RELATION WITH A SLICER APPARATUS AND SLICING METHOD

(71) Applicant: MAREL SALMON A/S, Stovring (DK)

(72) Inventor: Palle Kærgaard LARSEN, Vodskov (DK)

(21) Appl. No.: 16/629,737

(22) PCT Filed: Jun. 25, 2018
(86) PCT No.: PCT/EP2018/066974

§ 371 Date: Jan. 9, 2020

(30) Foreign Application Priority Data
Jul. 13, 2017 (DK) PA 2017 70571

(51) Int. Cl. B26D 7/20; B26D 1/08; B26D 7/26; A22C 25/08; A22C 25/18

(52) U.S. Cl. CPC B26D 7/20; B26D 1/08; B26D 2210/02; A22C 25/08; A22C 25/18; B26D 7/2628

(57) ABSTRACT

A cutting land is configured to be used in relation with a slicer apparatus for slicing food items, where the food items are conveyed by a conveying means along a conveying path, where a gap is provided extending across the conveying path, and where the cutting land is configured to be arranged in and along the gap. The cutting land comprises a recess facing at least one cutting blade such that during cutting the at least one cutting blade at least partly extends into the recess. The recess is defined by elongated and opposingly arranged flexible materials arranged in relation to each other such that during cutting the flexible materials exert elastic forces onto the at least one cutting blade causing the flexible materials and thus a width of the recess to follow the thickness of the at least one cutting blade.

### FIELD OF THE INVENTION

The present invention relates to a cutting land configured to be used in relation with a slicer apparatus for slicing food items.

### BACKGROUND OF THE INVENTION

FIG. 1 shows a slicer apparatus 100, e.g. such as disclosed in EP2393639 used for slicing in particular fish fillets 101, where the apparatus comprises a cutting means arranged in a conveying path, where the cutting means comprises a set of moveable reciprocating knives 103 that are moveable in a back and forth direction as indicated by the arrow, and a cutting land 102 arranged in a gap 105 between adjacent conveyors 104a,b arranged in an end-to-end manner, where the knives are moveable relative to the cutting land 102 and the surface of the conveyor path. The result of such a cutting may e.g. be very thin fish slices. However, the food item may contain e.g. tissues 106 that are very difficult to cut as shown in FIG. 2 resulting in the tissues follow the orientation of the cutting means 103 in the cutting land meaning that the cutting fails and adjacent slices may stick together.

### SUMMARY OF THE INVENTION

On the above background it is an object of embodiments of the present invention to provide an improved cutting land that overcomes the above mentioned problems.

In general, the invention preferably seeks to mitigate, alleviate or eliminate one or more of the above mentioned disadvantages of the prior art singly or in any combination.

In particular, it may be seen as an object of embodiments of the present invention to provide a cutting land that solves the above mentioned problems, or other problems.

To better address one or more of these concerns, in a first aspect of the invention a cutting land is provided configured to be used in relation with a slicer apparatus for slicing food items, where the food items are conveyed by a conveying means along a conveying path, where a gap is provided extending across the conveying path, and where the cutting land is configured to be arranged in and along the gap, where the cutting land comprises a recess facing at least one cutting blade such that during cutting the at least one cutting blade at least partly extends into the recess,

wherein the recess is defined by elongated and opposingly arranged flexible materials arranged in relation to each other such that during cutting the flexible materials exert elastic forces onto the at least one cutting blade causing the flexible materials and thus the width of the recess to follow the thickness of the at least one cutting blade.

The forces which are exerted by the flexible materials onto the at least one cutting blade may be provided by the elastic properties of the materials. The forces may be applied mutually, meaning that the materials exert forces in opposite directions on opposite sides of the at least one cutting blade.

The cutting land may be configured to be used in relation with a slicer apparatus for slicing food items, while the food items are conveyed by a conveying means along a conveying path.

The elastic forces exerting on the cutting blade ensure that difficult tissues will be cut, e.g. due to the pressure supplied on the cutting blade which is transferred to the food item that is being cut instead of allowing the difficult tissues to follow the cutting blade resulting in that the cut fails and adjacent cut portions stick together. The flexible materials may in one embodiment comprise a rubber, or plastic material, or composite material.

The slicing process is preferably performed by temporarily stopping the conveyor while each slicing step takes place, then advancing the food item that is being sliced until next slicing step takes place, then stopping the conveyor etc., where this is repeated until the food item has been sliced. Then the conveyor conveys the food items until the next food object is to be cut, and the process is then repeated.

In one embodiment, the cutting land is attached to a rotation drive mechanism configured to automatically adjust the angular position in relation to adjusted angular position of the at least one cutting blade. This is of a particular advantage if the food product is a salmon fillet, it may be ensured that all the cut slices have a similar areal and thus similar appearance.

In one embodiment, the at least one cutting blade comprises two reciprocating cutting blades. Such a blade arrangement which is well known to a person skilled in the art is in particular preferred when cutting food items such as fish fillet, e.g. salmon fillets, into slices.

In a second aspect of the invention, a slicer apparatus is provided for slicing food items, comprising:
a conveying means for conveying a food item to be cut, while the food item is conveyed along a conveying path, where a gap is provided extending across the conveying path,
at least one cutting blade,
a cutting land arranged in and along the gap, the cutting land comprising a recess such that during cutting the at least one cutting blade at least partly extends into the recess,
a first moving means connected to the at least one cutting blade for moving the at least one cutting blade a distance relative to the cutting land,
wherein the recess of the cutting land is defined by elongated and opposingly arranged flexible materials arranged in relation to each other such that during cutting the flexible materials exert elastic forces onto the at least one cutting blade causing the flexible materials and thus the width of the recess to follow the thickness of the at least one cutting blade.

In one embodiment, the slicer apparatus further comprises a second moving means connected to the at least one cutting blade for moving the at least one cutting blade angularly relative to the conveying path.

In one embodiment, the first and the second moving means are attached to the at least one cutting blade at opposite sides thereof and where the movement of the at least one cutting blade angularly relative to the conveying path is obtained via an angular movement of the first and the second moving means.

In one embodiment, the slicer apparatus further comprises a third moving means connected to the cutting land for adjusting at least an angular position of the cutting land around its longitudinal axis, wherein the third moving means is configured to independently adjust the at least angular position of the cutting land around its longitudinal axis.

In a third aspect of the invention, a method is provided for slicing food items with a slicer apparatus using a cutting land, where the food items are conveyed by a conveying means along a conveying path, where a gap is provided extending across the conveying path, and where the cutting land is configured to be arranged in and along the gap, where the cutting land comprises a recess facing at least one cutting blade such that during cutting the at least one cutting blade at least partly extends into the recess,

wherein the recess is defined by elongated and opposingly arranged flexible materials arranged in relation to each other such that during cutting the flexible materials exert elastic forces onto the at least one cutting blade causing the flexible materials and thus the width of the recess to follow the thickness of the at least one cutting blade.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 depicts a prior art slicer apparatus which are particularly suitable for cutting fish fillets into thin slices,

FIG. 2 depicts a prior art cutting land used in relation to the slicer apparatus shown in FIG. 1, and

FIGS. 3 and 4 depicts a cutting land according to the present invention configured to be used in relation to a slicer apparatus such as the one shown in FIG. 1.

### DESCRIPTION OF EMBODIMENTS

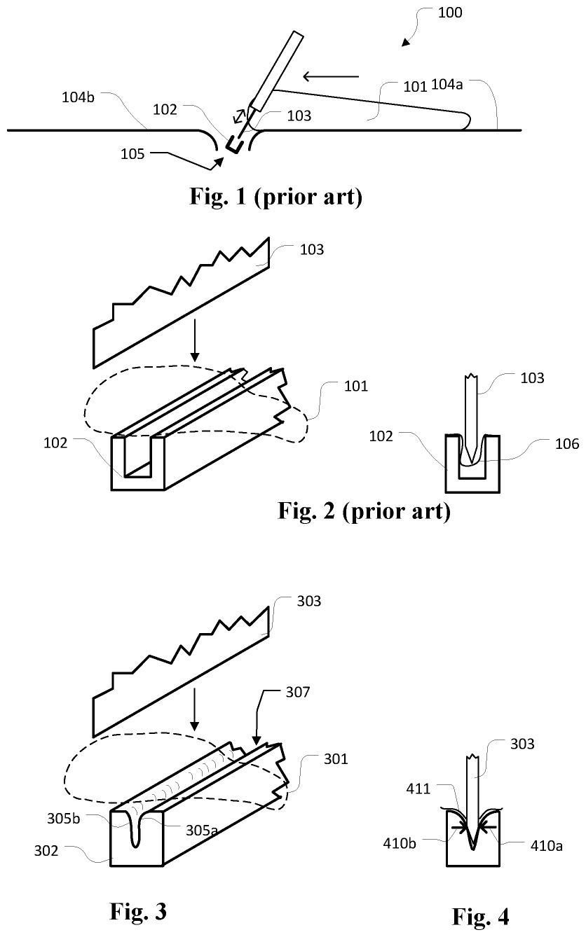

FIG. 3 depicts a cutting land 302 according to the present invention configured to be used in relation to a slicer apparatus 100 such as the one shown in FIG. 1 for slicing food items 301 while the food items are conveyed by a conveying means 104a,b along a conveying path, where a gap 105 is provided extending across the conveying path, and where the cutting land 302 is configured to be arranged in and along such a gap.

The cutting land according to the present invention comprises a recess 307 facing at least one cutting blade 303 such that during cutting the at least one cutting blade at least partly extends into the recess. The recess is defined by elongated and opposingly arranged flexible materials 305a,b, e.g. rubber, or plastic material, or composite material, arranged in relation to each other such that during cutting the flexible materials exert elastic forces 410a,b as shown in FIG. 4 onto the at least one cutting blade 303 causing the flexible materials and thus the width of the recess to follow the thickness of the at least one cutting blade. The elastic forces exerting on the cutting blade ensure that difficult tissues 411 will be cut as shown in FIG. 4, instead of e.g. following the movement of the cutting blade as shown in FIG. 1.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1.-8. (canceled)

9. A cutting land configured to be used in relation with a slicer apparatus for slicing food items, where the food items are conveyed by a conveying means along a conveying path, where a gap is provided extending across the conveying path, and where the cutting land is configured to be arranged in and along the gap, where the cutting land comprises a recess facing at least one cutting blade such that during cutting the at least one cutting blade at least partly extends into the recess,
wherein the recess is defined by elongated and opposingly arranged flexible materials arranged in relation to each other such that during cutting the flexible materials exert elastic forces onto the at least one cutting blade causing the flexible materials and thus a width of the recess to follow a thickness of the at least one cutting blade.

10. The cutting land according to claim 9, wherein the flexible materials comprise a rubber or plastic material.

11. The cutting land according to claim 9, wherein the cutting land is attached to a rotation drive mechanism configured to automatically adjust an angular position in relation to adjusted angular position of the at least one cutting blade.

12. The cutting land according to claim 9, wherein the cutting land is made of rubber, or plastic material, or composite material.

13. A slicer apparatus for slicing food items, comprising:
a conveying means for conveying a food item to be cut, where the food item is conveyed along a conveying path, where a gap is provided extending across the conveying path,
at least one cutting blade,
a cutting land arranged in and along the gap, the cutting land comprising a recess such that during cutting the at least one cutting blade at least partly extends into the recess,
a first moving means connected to the at least one cutting blade for moving the at least one cutting blade in distance relative to the cutting land,
wherein the recess of the cutting land is defined by elongated and opposingly arranged flexible materials arranged in relation to each other such that during cutting the flexible materials exert elastic forces onto the at least one cutting blade causing the flexible materials and thus a width of the recess to follow a thickness of the at least one cutting blade.

14. The slicer apparatus according to claim 13, further comprising:
a second moving means connected to the at least one cutting blade for moving the at least one cutting blade angularly relative to the conveying path.

15. The slicer apparatus according to claim 13, further comprising:
a third moving means connected to the cutting land for adjusting at least an angular position of the cutting land around its longitudinal axis,
wherein the third moving means is configured to independently adjust the at least angular position of the cutting land around its longitudinal axis.

16. A method of slicing food items with a slicer apparatus using a cutting land, where the food items are conveyed by a conveying means along a conveying path, where a gap is provided extending across the conveying path, and where the cutting land is configured to be arranged in and along the gap, where the cutting land comprises a recess facing at least one cutting blade such that during cutting the at least one cutting blade at least partly extends into the recess,
wherein the recess is defined by elongated and opposingly arranged flexible materials arranged in relation to each other such that during cutting the flexible materials exert elastic forces onto the at least one cutting blade causing the flexible materials and thus a width of the recess to follow a thickness of the at least one cutting blade.
